(19) United States
(12) Patent Application Publication
(10) Pub. No.: US 2025/0276567 A1
(43) Pub. Date: Sep. 4, 2025

(54) HARD FOLDING CAR COVER

(71) Applicant: TONY WAYGONG CHIU, Katy, TX (US)

(72) Inventors: Lizhao Wang, Katy, TX (US); Yi Lin, Katy, TX (US); Lei Lin, Katy, TX (US)

(21) Appl. No.: 19/211,333

(22) Filed: May 19, 2025

Related U.S. Application Data
(63) Continuation of application No. 18/173,240, filed on Feb. 23, 2023.

(51) Int. Cl. B60J 7/14; B60J 7/19

(52) U.S. Cl. CPC B60J 7/141; B60J 7/198

(57) ABSTRACT

The disclosure provides a hard folding car cover including a fixed cover plate and a reversible cover plate, wherein the fixed cover plate is provided with one and the reversible cover plate is provided with at least one, the reversible cover plate is connected to another reversible cover plate by a first rotational shaft system, the first rotational shaft system includes a first intermediate bar, the fixed cover plate is connected to the reversible cover plate by a second rotational shaft system, the second rotational shaft system includes a second intermediate bar wherein the second intermediate bar is of the same width as the first intermediate bar. The present disclosure sets the first intermediate bar and the second intermediate bar to equal width, making the first intermediate bar and the second intermediate bar require only one set of mold for processing, saving production costs and improving production and installation productivity.

### CROSS REFERENCES TO RELATED APPLICATIONS

This application is a continuation of U.S. patent application Ser. No. 18/173,240, filed Feb. 23, 2023, entitled “HARD FOLDING CAR COVER”, the entirety of which is incorporated herein by reference for all purposes.

### TECHNICAL FIELD

This invention is relevant to automobile accessories, especially a hard folding car cover.

### BACKGROUND OF THE INVENTION

The cargo hopper of a pickup truck (also known as a sedan truck) is used to carry goods. Since the cargo hopper of the pickup truck is open, in order to avoid the rain from wetting the goods inside the cargo hopper in rainy and snowy weather, a rear car cover is invented and installed on the cargo hopper of the pickup truck to cover the goods inside to prevent the goods in the cargo hopper from being wet by rain.

The existing car cover has different sizes of rotating shaft system between each cover plate, which is not only time consuming to manufacture, but also troublesome to install; secondly, the locking parts of the existing car cover are mostly a whole through groove, which needs to be disassembled as a whole during maintenance, which is also troublesome.

### BRIEF SUMMARY OF THE INVENTION

The purpose of the present invention is to make the rotating shaft system more convenient in both production and installation by changing the original rotating shaft structure.

In order to solve the above-mentioned problems, the technical solution adopted in the present invention is as follows:

A hard folding car cover, including a fixed cover plate and a reversible cover plate, the fixed cover plate is provided with one and the reversible cover plate is provided with at least one.

The reversible cover plate is connected to another reversible cover plate by a first rotational shaft system, the first rotational shaft system includes a first intermediate bar.

The fixed cover plate is connected to the reversible cover plate by a second rotating shaft system, the second rotating shaft system includes a second intermediate bar, the second intermediate bar is of the same width as the first intermediate bar.

When there is only one reversing cover plate, there is only a second rotating shaft system and no first rotating shaft system, which is also included here in the case of only one rotating shaft system.

When there is more than one reversing cover plate, there is both a first and a second rotating shaft system, both with the same width intermediate bar.

The reversible cover plate is connected with a limiting system, the limiting system includes a limiting component and a guide groove, the guide groove is connected to the reversible cover plate, the guide groove is set in correspondence with the limiting component, the fixed cover plate is connected with a fixing buckle groove system.

Further, the fixed cover plate is the third cover plate, the reversing cover plate includes a first cover plate and a second cover plate.

The first cover plate is connected to the second cover plate by a first rotating shaft system, the first rotating shaft system includes a first intermediate bar, the second cover plate is connected to the third cover plate by a second rotational shaft system, the second rotating shaft system includes a second intermediate bar, the second intermediate bar is of the same width as the first intermediate bar. By setting the first intermediate bar and the second intermediate bar to equal width, the first intermediate bar and the second intermediate bar require only one set of mould for processing, saving production costs and improving production and installation efficiency. At the same time, by setting the two intermediate bars to equal width, the middle part of the car cover can hold spare parts after folding, making the overall size of the car cover smaller after packing, which not only facilitates the delivery of the car cover but also reduces transportation costs.

Further, the first rotating shaft system includes a first frame and a second frame, the first frame and the second frame are rotatably connected to both sides of the first intermediate bar, both the first frame and the second frame are used for connecting the cover plate, specifically, the first frame is connected to the first cover plate, the second frame is connected to the second cover plate; the second rotating shaft system further includes a third frame and a forth frame, the third frame and forth frame are rotatably connected to both sides of the second intermediate bar, both the third frame and the forth frame are used for connecting the cover plate, specifically, the third frame is connected to the second cover plate, the forth frame is connected to the third cover plate.

Further, the first cover plate and second cover plate are respectively connected to a limiting system, the limiting system includes a limiting component and a guide groove, the guide groove is set in correspondence with the limiting component, the third cover plate is connected to a fixing buckle groove system. By setting the limiting system, the car cover can be locked with the cargo hopper, the car cover not only refer to the cover plate, both sides of the cover plate need to be connected with the cargo hopper so as to ensure that the car cover has good stability when the vehicle is running. By connecting the guide rail assembly on both sides of the cargo hopper, then locking the two ends of the cover plate with the guide rail to achieve the locking of the car cover, the limiting system is used to lock the car cover with the guide rail.

Further, the limiting system is a spanner groove system, the spanner groove system includes a spanner, a short spanner groove, a spanner fixing block, a spanner slider and a first T-rod, the short spanner groove is attached to the cover plate, the spanner fixing block is fixedly connected in the short spanner groove, the spanner slider is slidingly set in the short spanner groove, one end of the spanner is rotatably connected to the spanner slider by the first T-rod, the limiting component is a spanner, the guide groove is a short spanner groove. By setting the spanner groove system, the cover can be locked and opened by simply pulling the spanner, setting the short spanner groove on the cover plate greatly reduces the processing cost compared to the traditional through groove, moreover, each spanner corresponds to a short spanner groove, which is relatively independent and easy to replace.

Further, the limiting system is a lock bolt system, the lock bolt system includes a lock bolt, a handle, a first lock bolt groove, a second lock bolt groove and a wire support block, the first lock bolt groove and the second lock bolt groove are connected by a wire support block, the first lock bolt groove is slidingly connected with a lock bolt, the second lock bolt groove is slidingly connected with a lock bolt, the two lock bolts are connected to each other by a wire, the wire passes through the wire support block, the steel wire is threaded with a handle, the first lock bolt groove and the second lock bolt groove are both guide grooves, the lock bolt is a limiting component. By setting the lock bolt system, the car cover can be opened by simply pulling the handle, which drives the lock bolt contracted by the wire, by setting the first lock bolt groove and the second lock bolt groove on the cover plate, the two lock bolts are produced and installed independently of each other and are only connected by the wire support block.

Further, it includes a guide rail system, the guide rail system is connected to the cargo hopper by means of a clamp system, the guide rail system including two guide rails, the guide rail is provided with a guide rail notch, the guide rail notch is connected with a lock bolt positioning system, the lock bolt positioning system includes a lock bolt positioning system connected to the guide rail notch, the lock bolt positioning block is used for seating the lock bolt; the lock bolt positioning block is provided with a beveled contact surface, an insert section, a fixing hole and lateral sides, the insert section is inserted into guide rail, the screw passes through the fixing hole to connected lock bolt positioning block with the guide rail, the beveled contact surface is angled downwards, the two lateral sides are used to limit the lock bolt.

Further, the clamp system includes a left clamp, a right clamp, a fixing block, a screw and a second T-rod, the left clamp and right clamp are connected by a screw, the fixing block is connected to the left clamp, the fixing block is threaded to the screw, the left clamp includes a left clamp lug groove and a left clamp surface, the left clamp lug groove is used to attach the fixing block, the left clamp surface is used to clamp the guide rail, the fixing block includes a clamping section, the clamping section is seated with the left clamping lug groove, the right clamp includes a right clamping surface, the right clamping surface cooperates with the left clamping surface to clamp the cargo hopper to the guide rail, the bottom of the left clamp is connected to the bottom of the right clamp by a second T-rod, the bottom of the second T-rod is connected with a nut, the upper part of the second T-rod is a transverse section.

Further, the third cover plate is connected to the guide rails by a front bar fixing system, the front bar fixing system includes a stumbling positioning block, a stumbling fixing block, a screw positioning block and a plum screw; the stumbling positioning block and screw positioning block are attached to the third cover plate, the stumbling positioning block is provided with a positioning threaded hole, the screw positioning block is provided with an insertion block and a fixing hole, the screw connects the screw positioning block to the third cover plate through the fixing hole, the insertion block is set between the stumbling positioning block and the stumbling fixing block, the stumbling fixing block is connected to the guide rail, the stumbling fixing block is provided with a positioning recess and a connection hole, the connection hole is provided in correspondence with the positioning threaded hole, the plum screw includes a snap-in section and a threaded head, the plum screw passes through the connection hole and the positioning threaded hole, the threaded head is threaded into the positioning threaded hole, the insertion block is seated with the snap-in section. A stumbling fixing block and a stumbling positioning block are set to connect the third cover plate and the guide rail respectively, the stumbling fixing block and the stumbling positioning block are connected by a plum screw to achieve the connection between the third cover plate and the guide rail, and finally the plum screw is clamped in place by a screw positioning block to prevent the plum screw from loosening.

### BRIEF DESCRIPTION OF THE DRAWINGS

FIG. 1 is the structure schematic diagram 1 of new car cover of the present invention.

FIG. 2 is the structure schematic diagram 2 of new car cover of the present invention.

FIG. 3 is the partial enlarged view of part A in FIG. 2.

FIG. 4 is the structure schematic diagram of the Embodiment 6.

FIG. 5 is the partial enlarged view of part B in FIG. 4

FIG. 6 is the installation schematic diagram 1 of the lock bolt positioning system.

FIG. 7 is the installation schematic diagram 2 of the lock bolt positioning system.

FIG. 8 is the installation schematic diagram 3 of the lock bolt positioning system.

FIG. 9 is the connection schematic diagram of the clamp system.

FIG. 10 is the connection schematic diagram 1 of the clamp system.

FIG. 11 is the connection schematic diagram 2 of the clamp system.

FIG. 12 is the connection schematic diagram 1 of the front bar fixing system.

FIG. 13 is the connection schematic diagram 2 of the front bar fixing system.

In the picture: 11—Front bar fixing system; 1111—stumbling positioning block; 1112—Positioning recess, 112—stumbling fixing block, 113—Screw positioning block, 1131—Insertion block, 1132—Fixing hole, 114—Plum screw, 1141—Snap-in section, 1142—Threaded head, 12—Lock bolt system, 1201—Wire support block, 1202—First lock bolt groove, 1203—Second lock bolt groove, 13—Lock bolt positioning system, 131—Guide rail notch, 132—Lock bolt, 133—Lock bolt positioning block, 1331—Beveled contact surface, 1332—Lateral side, 1333—Insert section, 1334—Fixing hole, 14—Clamp system, 141—Left clamp, 1411—Left clamping lug groove, 1412—Left clamping surface, 142—Fixing block, 1422—Clamping section, 143—Right clamp, 1431—Right clamping surface, 144—Screw, 145—Second T-rod, 1451—Transverse section, 146—Nut, 16—Guide rail system, 161—Guide rail, 21—First rotating shaft system, 211—First frame, 212—First intermediate bar, 213—Second frame, 22—Spanner groove system, 222—Spanner, 223—Short spanner groove, 224—Spanner fixing block, 225—Spanner slider, 226—First T-rod, 23—Second rotating shaft system, 231—Third frame, 232—Second intermediate bar, 233—Forth frame, 24—Fixing buckle groove system, 31—First cover plate, 32—Second cover plate, 33—Third cover plate.

### DETAILED DESCRIPTION OF THE INVENTION

The following instruction further explains the invention's concrete implementation method.

In order to enable a clearer understanding of the objects mentioned above, features and advantages of the present invention, the invention is described in detail below in connection with the accompanying stumblingings and specific embodiments. It should be noted that the embodiments of the present application and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media, and it can be internal connection within two assemblies. For those of ordinary skill in this field, specific meanings of the above terms in the present invention can be understood in specific situations.

The specific embodiments of the present invention will be described in detail below in connection with the accompanying stumblingings. It should be understood that the specific embodiments described herein are intended only to illustrate and explain the present invention and not to limit it.

### Embodiment 1

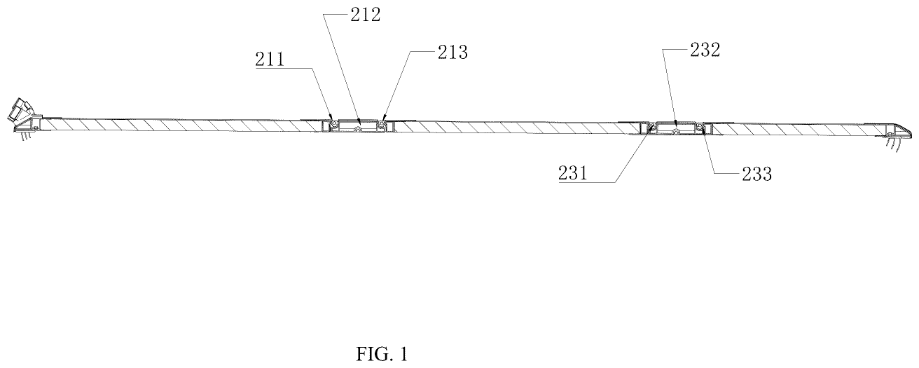

As shown in FIGS. 1, a hard folding car cover, including a plurality of cover plates, two adjacent plates are connected to each other by a rotational shaft system, the rotational shaft system is provided with at least one.

The cover plates body includes one fixed cover plate and at least one reversible cover plate, the rotational shaft system includes a first rotating shaft system 21 and a second rotating shaft system 23.

The reversible cover plate is connected to another reversible cover plate by a first rotating shaft system 21, the first rotating shaft system 21 includes a first intermediate bar 212.

The fixed cover plate is connected to the reversible cover plate by a second rotating shaft system 23, the second rotating shaft system 23 includes a second intermediate bar 232, the second intermediate bar 232 is of the same width as the first intermediate bar 212.

When there is only one reversing cover plate, there is only a second rotating shaft system 23 and no first rotating shaft system 21, which is also included here in the case of only one rotating shaft system.

When there is more than one reversing cover plate, there is both a first rotating shaft system 21 and a second rotating shaft system 23, both with the same width intermediate bar.

The reversible cover plate is connected with a limiting system, the limiting system includes a limiting component and a guide groove, the guide groove is connected to the reversible cover plate (here the connection can be fixed or removable), the guide groove is set in correspondence with the limiting component, the fixed cover plate is connected with a fixing buckle groove system.

### Embodiment 2

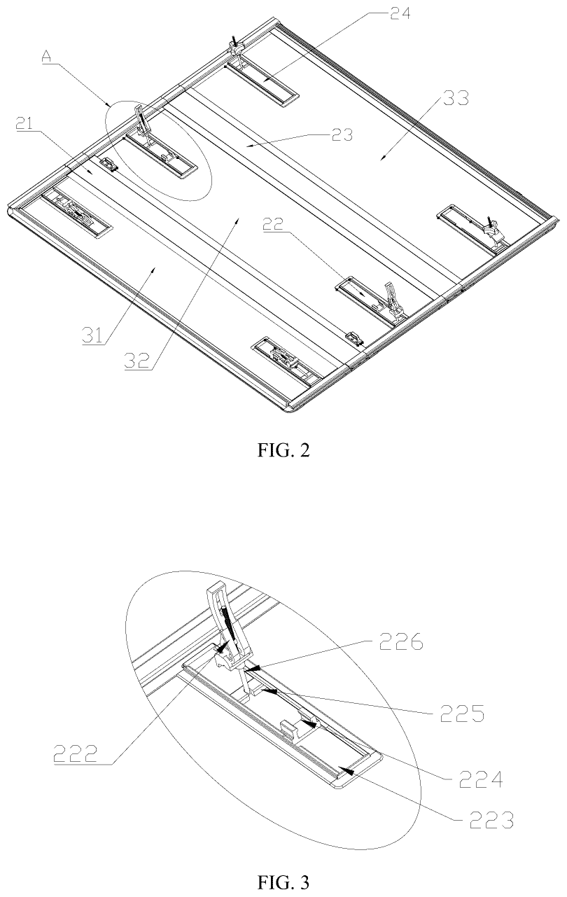

On the basis of Embodiment 1, as shown in FIGS. 2, the fixed cover plate is the third cover plate 33, the reversing cover plate includes a first cover plate 31 and a second cover plate 32.

The first cover plate 31 is connected to the second cover plate 32 by a first rotating shaft system 21, the first rotating shaft system includes a first intermediate bar 212.

The second cover plate 32 is connected to the third cover plate 33 by a second rotational shaft system 23, the second rotating shaft system 23 includes a second intermediate bar 232, the second intermediate bar 232 is of the same width as the first intermediate bar 212.

By setting the first intermediate bar 212 and the second intermediate bar 232 to equal width, the first intermediate bar 212 and the second intermediate bar 232 require only one set of mould for processing, saving production costs and improving production and installation efficiency. At the same time, by setting the two intermediate bars to equal width, the middle part of the car cover can hold spare parts after folding, making the overall size of the car cover smaller after packing, which not only facilitates the delivery of the car cover but also reduces transportation costs.

### Embodiment 3

On the basis of Embodiment 1 or 2, the first rotating shaft system 21 further includes a first frame 211 and a second frame 213, the first frame 211 and the second frame 213 are rotatably connected to both sides of the first intermediate bar 212, both the first frame 211 and the second frame 213 are used for connecting the cover plate, specifically, the first frame 211 is connected to the first cover plate 31, the second frame 213 is connected to the second cover plate 32.

The second rotating shaft system 23 further includes a third frame 231 and a forth frame 233, the third frame 231 and forth frame 233 are rotatably connected to both sides of the second intermediate bar 232, both the third frame 231 and the forth frame 233 are used for connecting the cover plate, specifically, the third frame 231 is connected to the second cover plate 32, the forth frame 233 is connected to the third cover plate 33.

The relative rotation of the frames and intermediate bars enables the opening and closing of the cover plate.

### Embodiment 4

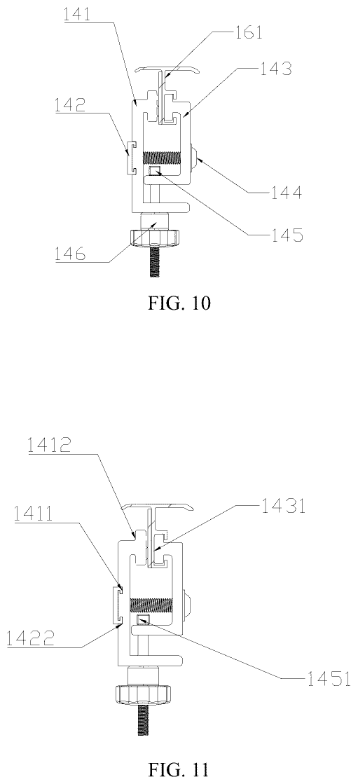

On the basis of Embodiment 3, as shown in FIGS. 10, the first cover plate 31 and second cover plate 32 are respectively connected to a limiting system, the limiting system includes a limiting component and a guide groove, the guide groove is set in correspondence with the limiting component, the third cover plate 33 is connected to a fixing buckle groove system.

By setting the limiting system, the car cover can be locked with the cargo hopper, the car cover not only refer to the cover plate, both sides of the cover plate need to be connected with the cargo hopper so as to ensure that the car cover has good stability when the vehicle is running. By connecting the guide rail 161 assembly on both sides of the cargo hopper, then locking the two ends of the cover plate with the guide rail 161 to achieve the locking of the car cover, the limiting system is used to lock the car cover with the guide rail 161.

### Embodiment 5

On the basis of Embodiment 4, as shown in FIGS. 3, the limiting system is a spanner groove system 22, the spanner groove system 22 includes a spanner 222, a short spanner groove 223, a spanner fixing block 224, a spanner slider 225 and a first T-rod 226, the short spanner groove 223 is attached to the cover plate, the spanner fixing block 224 is fixedly connected in the short spanner groove 223, the spanner slider 225 is slidingly set in the short spanner groove 223, one end of the spanner 222 is rotatably connected to the spanner slider 225 by the first T-rod 226.

The limiting component is a spanner 222, the guide groove is a short spanner groove 223.

By setting the spanner groove system 22, the cover can be locked and opened by simply pulling the spanner 222, and setting the short spanner groove 223 on the cover plate greatly reduces the processing cost compared to the traditional through groove, moreover, each spanner 222 corresponds to a short spanner groove 233, which is relatively independent and easy to replace.

### Embodiment 6

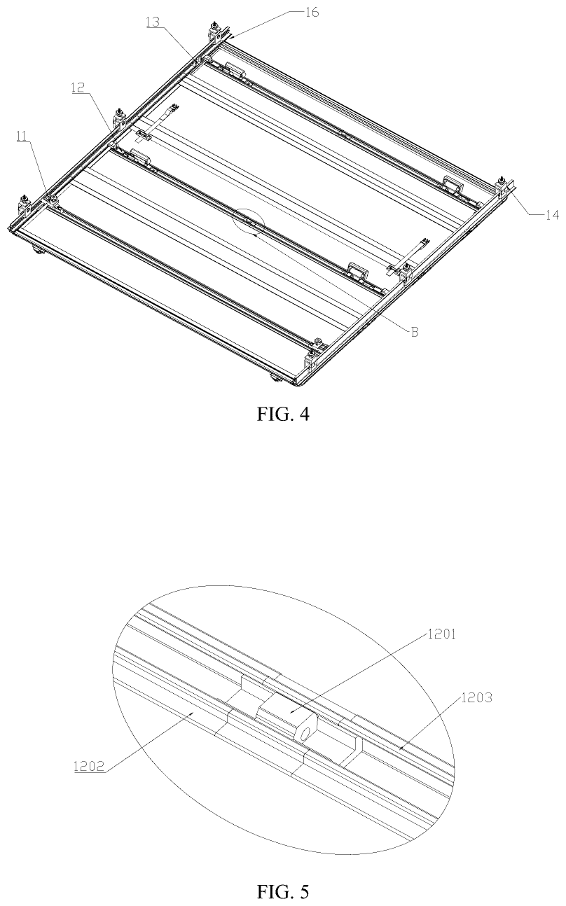

On the basis of Embodiment 4, as shown in FIGS. 4 and 5, the limiting system is a lock bolt system 12, the lock bolt system 12 includes a lock bolt 132, a handle, a first lock bolt groove 1202, a second lock bolt groove 1203 and a wire support block 1201.

The first lock bolt groove 1202 and the second lock bolt groove 1203 are connected by a wire support block 1201, the first lock bolt groove 1202 is slidingly connected with a lock bolt 132, the second lock bolt groove 1203 is slidingly connected with a lock bolt 132, the two lock bolts 132 are connected to each other by a wire, the wire passes through the wire support block 1201, the steel wire is threaded with a handle.

The first lock bolt groove 1202 and the second lock bolt groove 1203 are both guide grooves, the lock bolt 132 is a limiting component.

By setting the lock bolt system 12, the car cover can be opened by simply pulling the handle, which drives the lock bolt 132 contracted by the wire, by setting the first lock bolt groove 1202 and the second lock bolt groove 1203 on the cover plate, the two lock bolt grooves 132 are produced and installed independently of each other and are only connected by the wire support block 1201.

### Embodiment 7

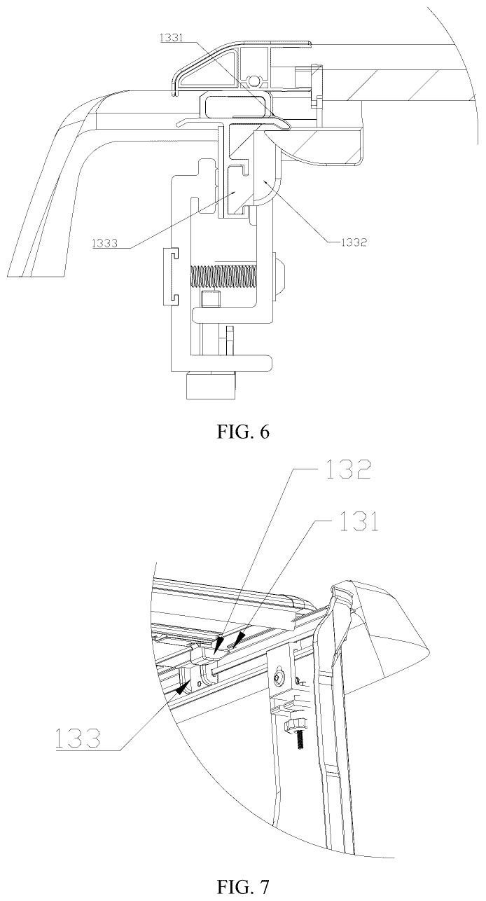

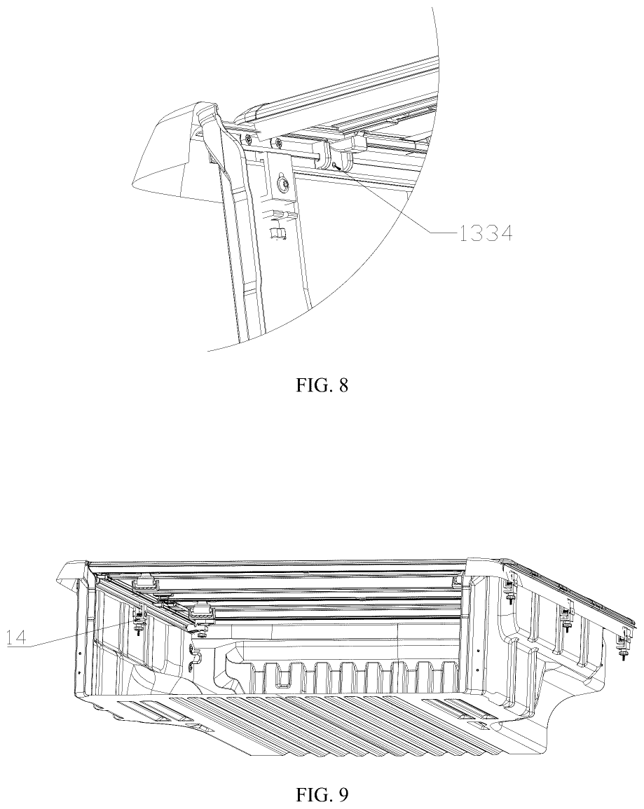

On the basis of Embodiment 5 or 6, as shown in FIGS. 6 to 8, it includes a guide rail system 16, the guide rail system 16 is connected to the cargo hopper by means of a clamp system 14, the guide rail system 16 including two guide rails 161.

The guide rail 161 is provided with a guide rail notch 131, the guide rail notch 131 is connected with a lock bolt positioning system 13, the lock bolt positioning system 13 includes a lock bolt positioning system 133 connected to the guide rail notch 131, the lock bolt positioning block 133 is used for seating the lock bolt 132.

The lock bolt positioning block 133 is provided with a beveled contact surface 1331, an insert section 1333, a fixing hole 1334 and lateral sides 1332, the insert section 1333 is inserted into guide rail 161, the screw passes through the fixing hole 1334 to connected lock bolt positioning block 133 with the guide rail 161, the beveled contact surface 1331 is angled downwards, the lateral sides 1332 are used to limit the lock bolt.

In order to make the car cover with good strength, the guide rail 161 is generally made of metal, so that it has good force strength, but the metal guide rail 161 makes the lock bolt 132 more laborious to lock, the locking of the lock bolt 132 is achieved by pressing the cover plate, as the contacting surface of the lock bolt 132 and the guide rail 161 is beveled, after the contact between the lock bolt 132 and the guide rail 161, the lock bolt 132 is first contracted by the pressure, then passing through the guide 161, and finally extended under the action of the spring to complete the locking. Since the guide rail 161 is made of metal, the metal material is not prone to deformation in the process of mutual extrusion with the lock bolt 132, which makes it difficult to lock the lock bolt 132. Therefore, remove one piece from the guide rail 161 and install a plastic lock bolt positioning block 133 instead, not only can the lateral sides 1332 of the lock bolt positioning block 133 be used to limit the lock bolt 132, but also the plastic parts are easier to produce deformation, making it easier to lock.

### Embodiment 8

On the basis of Embodiment 7, as shown in FIGS. 9 and 11, the clamp system 14 includes a left clamp 141, a right clamp 142, a fixing block 142, a screw 144 and a second T-rod 145, the left clamp 141 and right clamp 143 are connected by a screw 144, the fixing block 142 is connected to the left clamp 141, the fixing block 142 is threaded to the screw 144.

The left clamp 141 includes a left clamp lug groove 1411 and a left clamp surface 1412, the left clamp lug groove 1411 is used to attach the fixing block 142, the left clamp surface 1412 is used to clamp the guide rail 161.

The fixing block 142 includes a clamping section 1422, the clamping section 1422 is seated with the left clamping lug groove 1411.

The right clamp 143 includes a right clamping surface 1431, the right clamping surface 1431 cooperates with the left clamping surface 1412 to clamp the cargo hopper to the guide rail 161.

The bottom of the left clamp 143 is connected to the bottom of the right clamp 141 by a second T-rod 145, the bottom of the second T-rod 145 is connected with a nut 146, the upper part of the second T-rod 145 is a transverse section 1451.

A clamp system 14 is used to connect the guide rails 161 to the cargo hopper, thus enabling the car cover to be connected to the cargo hopper. In order to improve the stability of the connection between the guide rail 161 and the cargo hopper, a fixing block 142 is added to the left clamp 141. As the fixing block 142 both snaps into the left clamp 141 and threads into the screw 144, it can effectively prevent the screw 144 from loosening and improve the stability of the connection between the guide rail 161 and the cargo hopper.

### Embodiment 9

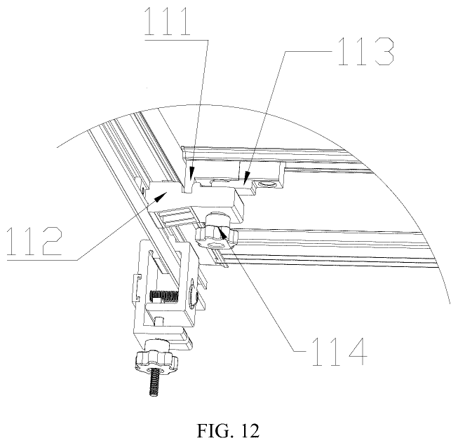

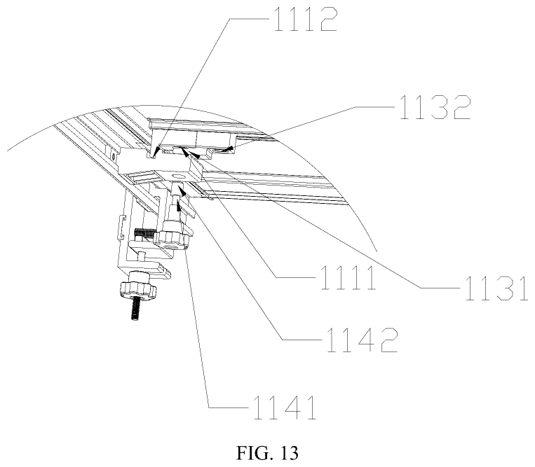

On the basis of Embodiment 8, as shown in FIGS. 12 and 13, the third cover plate 33 is connected to the guide rails 161 by a front bar fixing system 11, the front bar fixing system 11 includes a stumbling positioning block 111, a stumbling fixing block 112, a screw positioning block 113 and a plum screw 114.

The stumbling positioning block 111 and screw positioning block 113 are attached to the third cover plate 33, the stumbling positioning block 111 is provided with a positioning threaded hole 1111, the screw positioning block 113 is provided with an insertion block 1131 and a fixing hole 1334, the screw 144 connects the screw positioning block 113 to the third cover plate 33 through the fixing hole 1334, the insertion block 1131 is set between the stumbling positioning block 111 and the stumbling fixing block 112.

The stumbling fixing block 112 is connected to the guide rail 161, the stumbling fixing block 112 is provided with a positioning recess 1112 and a connection hole, the connection hole is provided in correspondence with the positioning threaded hole 1111.

The plum screw 114 includes a snap-in section 1141 and a threaded head 1142, the plum screw 114 passes through the connection hole and the positioning threaded hole 1111, the threaded head 1142 is threaded into the positioning threaded hole 1111, the insertion block 1131 is seated with the snap-in section 1141.

A stumbling fixing block 112 and a stumbling positioning block 111 are set to connected the third cover plate 33 and the guide rail 161 respectively, the stumbling fixing block 112 and the stumbling positioning block 111 are connected by a plum screw 114 to achieve the connection between the third cover plate 33 and the guide rail 161, and finally the plum screw 114 is clamped in place by a screw positioning block 113 to prevent the plum screw 114 from loosening.

The invention is not limited to the above-mentioned optional embodiments, anyone can come up with various other forms of products under the inspiration of the invention, however, regardless of any changes in its shape or structure, all technical solutions that fall within the scope defined by the claims of the present invention shall fall within the scope of protection of the invention.

What is claimed is:

1. A hard folding car cover, wherein, including two cover plates and one shaft system, the two cover plates are connected by the shaft system.

2. A hard folding car cover including a plurality of cover plates, two adjacent plates are connected to each other by a rotational shaft system, wherein the rotational shaft system is provided with at least two;
wherein the cover plates body includes one fixed cover plate and at least one reversible cover plate, the rotational shaft system includes a first rotating shaft system (21) and a second rotating shaft system (23),
the reversible cover plate is connected to another reversible cover plate by a first rotating shaft system (21), the first rotating shaft system (21) includes a first intermediate bar (212),
the fixed cover plate is connected to the reversible cover plate by a second rotating shaft system (23), the second rotating shaft system (23) includes a second intermediate bar (232), the second intermediate bar (232) is of the same width as the first intermediate bar (212).

3. The hard folding car cover according to claim 2, wherein the reversible cover plate is connected with a limiting system, the limiting system includes a limiting component and a guide groove, the guide groove is connected to the reversible cover plate, the guide groove is set in correspondence with the limiting component, the fixed cover plate is connected with a fixing buckle groove system (24).

4. The hard folding car cover according to claim 2, wherein the fixed cover plate is the third cover plate (33), the reversing cover plate includes a first cover plate (31) and a second cover plate (32);
the first cover plate (31) is connected to the second cover plate (32) by a first rotating shaft system (21);
the second cover plate (32) is connected to the third cover plate (33) by a second rotational shaft system (23).

5. The hard folding car cover according to claim 4, wherein the first cover plate (31) and second cover plate (32) are respectively connected to a limiting system, the limiting system includes a limiting component and a guide groove, the guide groove is connected to the reversible cover plate, the guide groove is set in correspondence with the limiting component, the third cover plate (33) is connected to a fixing buckle groove system (24).

6. The hard folding car cover according to claim 4, wherein it includes a guide rail system (16), the guide rail system (16) is connected to the cargo hopper by means of a clamp system (14), the guide rail system (16) including two guide rails (161);
the guide rail (161) is provided with a guide rail notch (131), the guide rail notch (131) is connected with a lock bolt positioning system (13), the lock bolt positioning system (13) includes a lock bolt positioning system (13) connected to the guide rail notch (131), the lock bolt positioning block (133) is used for seating the lock bolt (132);
the lock bolt positioning block (133) is provided with a beveled contact surface (1331), an insert section (1333), a fixing hole (1334) and lateral sides (1332), the insert section (1333) is inserted into the guide rail (161), the screw passes through the fixing hole to connected the lock bolt positioning block (133) with the guide rail (161), the beveled contact surface (1331) is angled downwards, the lateral sides (1332) are used to limit the lock bolt.

7. The hard folding car cover according to claim 6, wherein the third cover plate (33) is connected to the guide rails (161) by a front bar fixing system (11), the front bar fixing system (11) includes a stumbling positioning block (111), a stumbling fixing block (112), a screw positioning block (113) and a plum screw (114);
the stumbling positioning block (111) and screw positioning block (113) are attached to the third cover plate (33), the stumbling positioning block (111) is provided with a positioning threaded hole (1111), the screw positioning block (113) is provided with an insertion block (1131) and a fixing hole (1334), the screw (144) connects the screw positioning block (113) to the third cover plate (33) through the fixing hole (1334), the insertion block (1131) is set between the stumbling positioning block (111) and the stumbling fixing block (112);
the stumbling fixing block (112) is connected to the guide rail (161), the stumbling fixing block (112) is provided with a positioning recess (1112) and a connection hole, the connection hole is provided in correspondence with the positioning threaded hole (1111);
the plum screw (114) includes a snap-in section (1141) and a threaded head (1142), the plum screw (114) passes through the connection hole and the positioning threaded hole (1111), the threaded head (1142) is threaded into the positioning threaded hole (1111), the insertion block (1131) is seated with the snap-in section (1141).

8. The hard folding car cover according to claim 2, wherein the first rotating shaft system (21) further includes a first frame (211) and a second frame (213), the first frame (211) and the second frame (213) are rotatably connected to both sides of the first intermediate bar (212), both the first frame (211) and the second frame (213) are used for connecting the cover plate;
the second rotating shaft system (23) further includes a third frame (231) and a forth frame (233), the third frame (231) and forth frame (233) are rotatably connected to both sides of the second intermediate bar (232), both the third frame (231) and the forth frame (233) are used for connecting the cover plate.

9. The hard folding car cover according to claim 5, wherein the limiting system is a spanner groove system (22), the spanner groove system (22) includes a spanner (222), a short spanner groove (223), a spanner fixing block (224), a spanner slider (225) and a first T-rod (226), the short spanner groove (223) is attached to the cover plate, the spanner fixing block (224) is fixedly connected in the short spanner groove (223), the spanner slider (225) is slidingly set in the short spanner groove (223), one end of the spanner (222) is rotatably connected to the spanner slider (225) by the first T-rod (226).

10. The hard folding car cover according to claim 5, wherein the limiting system is a lock bolt system (12), the lock bolt system (12) includes a lock bolt (132), a handle, a first lock bolt groove (1202), a second lock bolt groove (1203) and a wire support block (1201);
the first lock bolt groove (1202) and the second lock bolt groove (1203) are connected by a wire support block (1201), the first lock bolt groove (1202) is slidingly connected with a lock bolt (132), the second lock bolt groove (1203) is slidingly connected with a lock bolt (132), the two lock bolt (132) are connected to each other by a wire, the wire passes through the wire support block (1201), the steel wire is threaded with a handle.

11. The hard folding car cover according to claim 6, wherein the clamp system (14) includes a left clamp (141), a right clamp (143), a fixing block (142), a screw (144) and a second T-rod (145), the left clamp (141) and right clamp (143) are connected by a screw (144), the fixing block (142) is connected to the left clamp (141), the fixing block (142) is threaded to the screw (144);
the left clamp (141) includes a left clamp lug groove (1411) and a left clamp surface (1412), the left clamp lug groove (1411) is used to attach the fixing block (142), the left clamp surface (1412) is used to clamp the guide rail (161);
the fixing block (142) includes a clamping section (1422), the clamping section (1422) seating with the left clamping lug groove (1411),
the right clamp (143) includes a right clamping surface (1431), the right clamping surface (1431) cooperates with the left clamping surface (1412) to clamp the cargo hopper to the guide rail (161), the bottom of the right clamp (143) is connected to the bottom of the left clamp (141) by a second T-rod (145), the bottom of the second T-rod (145) is connected with a nut (146), the upper part of the second T-rod (145) is a transverse section (1451).
